(19) United States
(12) Patent Application Publication
(10) Pub. No.: US 2008/0108234 A1
(43) Pub. Date: May 8, 2008

(54) Clamping Apparatus and Method for Connecting a Ground Conductor to a Grounding Member

(75) Inventors: Reuben E. Clark, Cary, NC (US); Gary Weise, San Juan Capistrano, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Consolidated Manufacturing International, LLC

(21) Appl. No.: 11/933,794

(22) Filed: Nov. 1, 2007

Related U.S. Application Data
(63) Continuation-in-part of application No. 10/935,569, filed on Sep. 7, 2004, now abandoned.
(60) Provisional application No. 60/500,494, filed on Sep. 5, 2003.

(51) Int. Cl. H01R 4/66

(52) U.S. Cl. 439/108

(57) ABSTRACT

A clamping apparatus is provided, comprising a continuous annular wall having therein a connection area, and an inward facing surface including a concave portion. First and second leg portions continuously, smoothly, and uninterruptedly extend from the concave portion, with a single continuous and uninterrupted taper having a continuously increasing taper rate, to spaced-apart leg ends. A concave trough portion is disposed opposite to the concave portion. A convex interface extends between each of the first and second leg ends and the trough portion, with an increased taper rate with respect to the single continuous taper, before continuously, smoothly and uninterruptedly transitioning to a decreased taper rate upon extending to the trough portion, thereby forming lateral support members for maintaining the ground conductor laterally with respect to the trough portion. Associated apparatuses and methods for connecting a ground conductor to a grounding member are also provided.

### CROSS-REFERENCE TO RELATED APPLICATIONS

This application is a continuation-in-part of U.S. patent application Ser. No. 10/935,569, filed Sep. 7, 2004, which claims priority to U.S. Provisional Patent Application No. 60/500,494, filed on Sep. 5, 2003, the entire contents of which are hereby incorporated by reference.

### BACKGROUND OF THE INVENTION

1. Field of the Invention

Embodiments of the present invention are directed to apparatuses and methods for connecting ground conductors to ground members and, more particularly, to a clamping apparatus for connecting a wide range of ground conductor sizes to a wide range of grounding member sizes.

2. Description of Related Art

Grounding clamps have been used to electrically connect electrical devices to a grounding member, such as rebar, pipe, and ground rods, in order to provide a proper ground for the electrical devices, where typically at least a portion of the grounding members are underground. More specifically, the grounding clamp is typically fastened around the grounding member by some adjustable clamping mechanism. An electrically conductive cable, i.e., a ground conductor, is attached to the grounding clamp in some manner and also attached to a ground terminal at the electrical device, thereby providing a path for any ground currents from the electrical device through the grounding clamp down the grounding member and into the ground where it can be safely dissipated.

Different grounding clamp designs have been disclosed in the prior art. Conventional grounding clamps, however, are limited by their design to accepting a narrow selection of grounding member sizes, and are often limited to only a single size grounding member. For example, a conventional ground clamp may be specially designed to accommodate only a ⅝″ diameter grounding member and a limited range of ground conductor sizes. In addition, within each clamp size there are typically two or three versions of the clamp to accommodate higher torque values, e.g., heavy duty and light duty, and/or different range of ground conductor sizes.

This specialized design approach causes suppliers to stock many different sizes and duties of clamps to meet the needs of their customers, e.g., contractors. In addition, contractors have to keep different sizes and duties of clamps on hand and have to take time to investigate each project in detail to ascertain which size and duty of ground clamp is needed at each installation site in the project.

For example, U.S. Pat. No. 5,494,462 describes a ground rod clamp made for a single specific size ground rod. The clamp has an inner region distinctly and particularly defining three different constant radii circles. A first circle has the greatest radius and is for sliding the clamp over the ground rod. This radius is greater than the radius of the ground rod to allow the clamp to slide over the rod when the rod has been damaged during installation, e.g., mushroomed by repeated hammer strikes. The second circle has a radius matched to that of the ground rod to seat the ground rod snugly in place. The third circle provides a crescent shaped space below the ground rod for ground wire(s). One problem with this design is that the clamp is sized specifically for only one size ground rod. Larger sized ground rods would not fit into the second circle to connect to the ground wire(s) below. Another problem is the third circle's crescent shaped space does not provide adequate lateral support to the ground wire(s). The ground rod must fit snugly into the second circle to prevent the ground wire(s) from coming loose and sliding past the ground member. That is, if one were to try to use a smaller ground rod, the ground wire(s) could slide by the ground rod in the extra space along side the ground rod, since the crescent shape does not provide adequate support to the ground wire(s).

What is needed is a more universal clamp having a continuously tapering shape that can accommodate a variety of grounding member sizes with a wide range of ground conductor sizes while providing lateral support to a ground conductor and that can be rated for high torque use, i.e., heavy duty, to replace the many different sizes and duties of clamps currently available.

### BRIEF SUMMARY OF THE INVENTION

The above and other needs are met by embodiments of the present invention which, according to one aspect, provides a universal clamping apparatus and method that can accommodate a variety of grounding member sizes with a wide range of ground conductor sizes and can be rated for high torque use, i.e., heavy duty, to replace the many different sizes and duties of clamps currently available.

One aspect of the present invention thus provides an apparatus for connecting a ground conductor to a grounding member. Such an apparatus comprises a continuous annular wall encompassing and defining an inner region adapted to have therein a connection area for the ground conductor to contact the grounding member, wherein the continuous annular wall includes an inward facing surface and an outward facing surface with respect to the inner region. The inward facing surface includes an arcuate portion having a first average radius of curvature and opposing ends. The arcuate portion is further configured so as to be concave with respect to the connection area and defines a medially-disposed aperture extending through the annular wall substantially transversely to the inner region. First and second leg portions continuously, smoothly, and uninterruptedly extend from the respective opposing ends of the arcuate portion, and cooperate with the opposing ends to define a single continuous and uninterrupted taper having a continuously increasing taper rate, without any projection inward toward the connection area, away from the arcuate portion and to respective spaced-apart leg ends. An arcuate trough portion is disposed substantially opposite to the arcuate portion and has opposing ends and a second average radius of curvature less than the first average radius of curvature. The second average radius of curvature is less than half of a distance between the spaced-apart leg ends. The trough portion is further configured so as to be concave with respect to the connection area and has a depth greater than one-third of a width thereof. An arcuate interface extends between each of the first and second leg ends and the respective opposing ends of the trough portion, wherein the arcuate interfaces are configured so as to be convex with respect to the connection area. Each arcuate interface thereby has an increased taper rate with respect to the single continuous taper of, and as the arcuate interface extends from, the respective first and second leg ends. Each arcuate interface further continuously, smoothly and uninterruptedly transitions to a decreased taper rate upon extending to the respective opposing ends of the trough portion. The arcuate interfaces thereby forms opposing lateral support members adapted to maintain the ground conductor laterally within the trough portion when the ground conductor is received thereby.

Another aspect of the present invention provides an apparatus for connecting a ground conductor to a grounding member. Such an apparatus comprises a clamp body formed from a single continuous strip of a metallic material having opposed longitudinal end portions configured to overlap such that the single strip defines an interior region adapted to have therein a connection area for the ground conductor to contact the grounding member. The clamp body further includes spaced-apart first and second legs extending substantially perpendicularly to the overlapped opposed end portions and away therefrom to respective spaced-apart leg ends. First and second trough legs extend from the respective spaced-apart leg ends and are directed away from the overlapped opposed end portions. The first and second trough legs further converge to form a trough portion of the clamp body. An aperture is defined by each of the overlapped opposed ends of the clamp body, wherein the apertures are aligned along an axis extending substantially transversely to the inner region.

Still another aspect of the present invention provides a method for connecting a ground conductor to a grounding member. Such a method comprises inserting the ground conductor through an inner region defined and encompassed by a continuous annular wall, wherein the inner region is adapted to have therein a connection area for the ground conductor to contact the grounding member. The continuous annular wall has an inward facing surface and an outward facing surface with respect to the inner region. The inward facing surface includes an arcuate portion having a first average radius of curvature and opposing ends. The arcuate portion is further configured so as to be concave with respect to the connection area and defines a medially-disposed aperture extending through the annular wall substantially transversely to the inner region. First and second leg portions continuously, smoothly, and uninterruptedly extend from the respective opposing ends of the arcuate portion, and cooperate with the opposing ends to define a single continuous and uninterrupted taper having a continuously increasing taper rate, without any projection inward toward the connection area, away from the arcuate portion and to respective spaced-apart leg ends. An arcuate trough portion is disposed substantially opposite to the arcuate portion and has opposing ends and a second average radius of curvature less than the first average radius of curvature, wherein the second average radius of curvature is less than half of a distance between the spaced-apart leg ends. The trough portion is further configured so as to be concave with respect to the connection area and has a depth greater than one-third of a width thereof. An arcuate interface extends between each of the first and second leg ends and the respective opposing ends of the trough portion, wherein the arcuate interfaces are configured so as to be convex with respect to the connection area. Each arcuate interface thereby has an increased taper rate with respect to the single continuous taper of, and as the arcuate interface extends from, the respective first and second leg ends. Each arcuate interface further continuously, smoothly and uninterruptedly transitions to a decreased taper rate upon extending to the respective opposing ends of the trough portion. The arcuate interfaces thereby forms opposing lateral support members adapted to maintain the ground conductor laterally within the trough portion when the ground conductor is received thereby. The grounding member is inserted through the inner region and moved along the inner region toward the trough portion so as to contact the ground conductor received by the trough portion. A threaded rod, threadedly engaged with the annular wall defining the aperture, is threaded toward the trough portion such that a securement end thereof provides a clamping force for clamping the grounding member against the ground conductor. The ground conductor is thereby retained with respect to the trough portion by the grounding member in cooperation with the lateral support members.

Aspects of the present invention thus provide significant advantages as further detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an apparatus for connecting a ground conductor to a grounding member according to one aspect of the present invention;

FIG. 2 illustrates, in use, an apparatus for connecting a ground conductor to a grounding member according to one aspect of the present invention;

FIGS. 3-10 illustrate various combinations of grounding members and ground conductors connected with an apparatus according to one embodiment of the present invention;

FIG. 11 illustrates an apparatus for connecting a ground conductor to a grounding member according to an alternate aspect of the present invention;

FIG. 12 illustrates a partial cross-sectional view of the apparatus of the alternate embodiment shown in FIG. 11; and

FIG. 13 illustrates an apparatus for connecting a ground conductor to a grounding member according to yet another alternate aspect of the present invention,

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

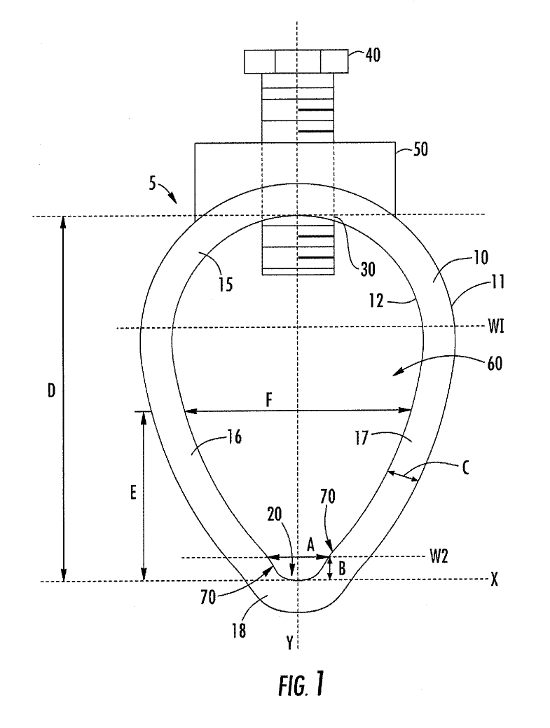

A side view of an apparatus for connecting a ground conductor to a grounding member, e.g., a ground clamp, is shown in FIG. 1. A main body 5 comprises a continuous annular wall 10 that defines an inner region 60. The inner region 60 is adapted to receive a ground conductor and a grounding member therein, wherein contact therebetween determines a connection area within the inner region 60. The annular wall 10 includes an outer or outward facing surface 11 and an inner or inward facing surface 12.

The inward facing surface 12 includes an arcuate (concave with respect to the connection area) portion 15 having a first radius of curvature. The main body 5 also includes an end 18 opposing the arcuate portion 15, wherein the inward facing wall 12 further includes an arcuate (concave with respect to the connection area) trough portion 20 opposing the arcuate portion 15 along an axis Y and having a second radius of curvature. First and second leg portions 16, 17 extend from opposing ends of the arcuate portion 15 of the inward facing surface 12. According to one aspect, the transition between each of the ends of the arcuate portion 15 and the respective first and second leg portions 16, 17 are continuous, smooth, and uninterrupted. Such a transition may occur, for example, at imaginary axis W1.

The first and second leg portions 16, 17 are further configured to cooperate with the opposing ends of the arcuate portion 15 to define a single continuous and uninterrupted taper having a continuously increasing taper rate, without any projection inward toward the connection area. The first and second leg portions 16, 17 further extend away from the arcuate portion 15 and terminate at respective spaced-apart leg ends, for example, at imaginary axis W2.

An arcuate interface (about the intersection between the inward facing wall 12 and the imaginary axis W2) extends between each of the first and second leg ends of the first and second leg portions 16, 17 and the respective opposing ends of the trough portion 20. Each arcuate interface is configured so as to be convex with respect to the connection area. As such, each arcuate interface has an increased taper rate with respect to the single continuous taper, as each arcuate interface extends from the respective first and second leg ends of the first and second leg portions 16, 17. Each arcuate interface further continuously, smoothly and uninterruptedly transitions to a decreased taper rate upon extending to the respective opposing ends of the trough portion 20. The arcuate interfaces thereby form opposing lateral support members 70 (i.e., convex with respect to the connection area within the inner region 60) adapted to maintain the ground conductor with respect to the trough portion 20, as discussed further herein.

The arcuate portion 15 of the annular wall 15 also defines a medially disposed threaded hole or aperture 30 extending therethrough. The threaded aperture 30 is configured to receive a threaded rod 40, such as a bolt or screw. The threaded rod 40 preferably comprises stainless steel or bronze. The main body 5 can optionally include support block 50 operably engaged with the arcuate portion 15 for stabilizing the clamp body 5 and adding stabilizing support around the threaded hole 30. For example, the support block 50 may provide additional threaded engagement with the threaded rod 40, which may allow a higher clamping force to be applied to the connection area by cooperation of the clamp body 5 with the threaded rod 40.

A threaded rod 40 can be threaded and advanced through the threaded hole 30 in a direction toward the trough portion 20, along the axis Y. A coarse or fine thread may be used, however a finer thread may preferred because additional torque may be realized in comparison to a coarse thread. The threaded hole 30 is preferably configured such that the axis Y bisects the trough portion 20, substantially perpendicular to imaginary axes W2 and X, as shown in FIG. 1.

The second average radius of curvature of the trough portion 20 less than the first average radius of curvature, and may also be less than half of the distance between the spaced-apart leg ends of the first and second leg portions 16, 17. The trough portion 20 is further configured, for instance, to have a depth greater than one-third of the width thereof. For example, the trough portion 20 may have a radius of curvature of approximately 1.85 mm, though the radius of curvature may vary along the trough portion 20. In one embodiment, the second average radius of curvature of the trough portion 20 is about 2 mm. The radius of curvature of the arcuate portion 15 may be, for instance, at least 8 mm, and may also vary. In any instance, the first average radius of curvature of the arcuate portion 15 is greater than the second average radius of curvature of the trough portion 20.

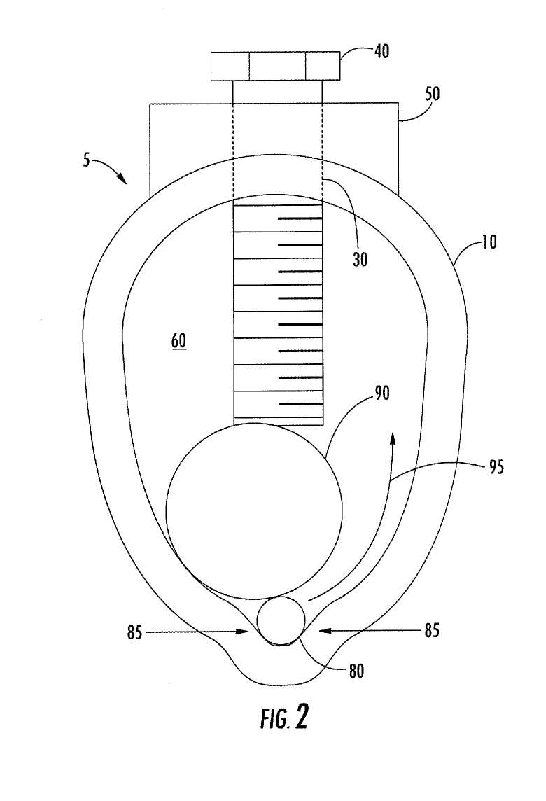

Since the second average radius of curvature of the trough portion 20 is less than half the distance between the spaced-apart leg ends of the first and second leg portions 16, 17, lateral support members 70 (whereby the inward facing wall 12 extends toward the connection area) are formed by the arcuate interfaces therebetween. In this manner, the lateral support members 70 provide lateral support for a ground conductor received by the trough portion 20, as more particularly discussed with respect to FIG. 2. The trough portion 20 may have, for example, a depth B of between about 1.5 mm and about 2 mm, and preferably about 1.7 mm; and a width A of between about 3 mm and about 4.5 mm, and preferably about 4 mm at the widest point.

As shown in FIG. 2, a ground conductor 80 may be received by the trough portion 20, and a grounding member 90 may also be positioned within the inner region 60 in contact with the ground conductor 80 (to thereby form the connection area). The threaded rod 40 may then be threadedly advanced through the threaded hole 30 toward the trough portion 20 until a securement end of the threaded rod 40 applies a force to the grounding member 90 and the ground conductor 80, through cooperation with the trough portion 20. The lateral support members 70 further provide lateral support 85 for maintaining and retaining the ground conductor 80 with respect to the trough portion 20. That is, the lateral support members 70 are positive and, in some instances, pronounced elements for providing the lateral support 85 which may be particularly important, for example, for a ground conductor 80 having a relatively small size.

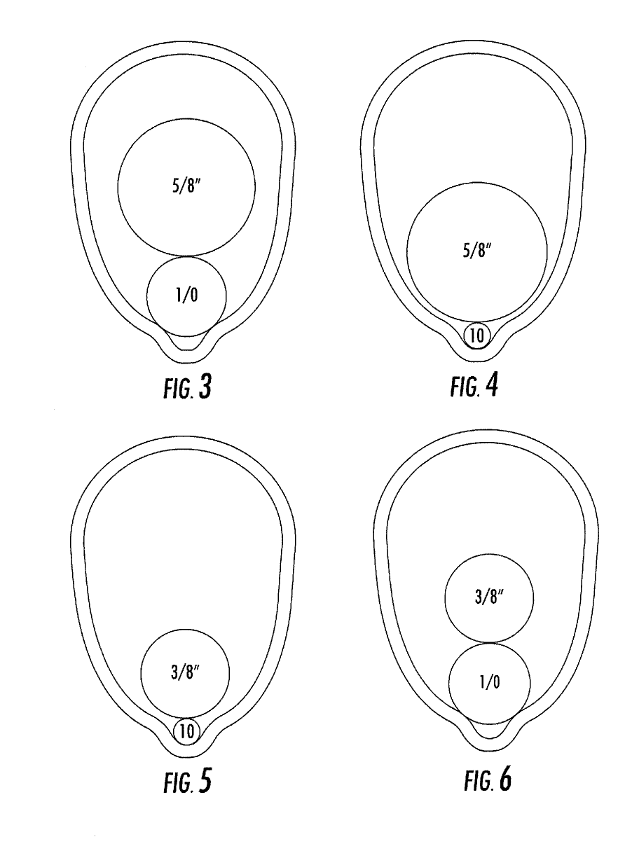

As shown in FIG. 2, the lateral support members 70 prevent the ground conductor 80 from being forced out of the trough portion 20 by the grounding member 90, as illustrated by the arrow 95, at least in part due to the lateral support 85 provided thereby. The particular configuration of trough portion 20 provides such lateral support 85 to ground conductors through a range of sizes, as discussed more specifically with reference to FIGS. 3-10. According to one aspect, the first and second leg portions 16, 17, in cooperation with the lateral support members 70 and the trough portion 20, are configured such that at least a portion of the grounding member 90 is intersected by the axis Y in order for the grounding member 90 to be acted upon by the threaded rod 40. In doing so, the first and second leg portions 16, 17, in cooperation with the lateral support members 70 and the trough portion 20, may also be configured to maintain the grounding member 90 in intersecting relation with the axis Y such that the ground conductor 80 received by the trough portion 20 does not have sufficient clearance between the grounding member 90 and either lateral support member 70 to be forced out of the trough portion 20.

As previously discussed, the first and second leg portions 16, 17 are configured to cooperate with the opposing ends of the arcuate portion 15 to define a single continuous and uninterrupted taper having a continuously increasing taper rate, without any projection inward toward the connection area, as the first and second leg portions 16, 17 extend away from the arcuate portion 15 toward the respective spaced-apart leg ends leading to the lateral support members 70. In some aspects, the interface between the first and second leg portions 16, 17 and the arcuate portion 15 may occur at imaginary axis W1, which may correspond to the widest point of the inward facing surface 12. The first and second leg portions 16, 17 continuously and uninterruptedly taper inward toward the connection area (i.e., concave with respect to the connection area) such that the taper rate continuously increases toward the lateral support members 70. With such a configuration, aspects of the present invention include an inward facing surface 12 without any substantial inward protrusions, except for the lateral support members 70, toward the connection area within the inner region 60. As also previously discussed, the particular configuration of the inward facing surface 12 thereby facilitates the application of a clamping force to form a connection between one or more grounding members ranging in size and one or more ground conductors ranging in size.

As illustrated in FIGS. 3-10, the ground clamp is adapted to accept a range of grounding member sizes and a range of ground conductor sizes, i.e., wire gauges. In each of these figures, the grounding member 90 is shown above the ground conductor 80, with approximate relative sizes not necessarily being illustrated to scale. The sizes of the grounding member 90 are indicated in inches and the sizes of the ground conductor are indicated according to the American Wire Gauge (AWG) scale. Table 1 below lists some relative ground conductor diameters according to the AWG scale.

TABLE 1

| AWG | Diameter (in.) | Diameter (mm) |
|---|---|---|
| #10 | 0.116 | 2.95 |
| #8 | 0.146 | 3.71 |
| #6 | 0.184 | 4.62 |
| #4 | 0.232 | 3.89 |
| #2 | 0.292 | 7.42 |
| #1 | 0.332 | 8.43 |
| #1/0 | 0.373 | 9.47 |

FIGS. 3-10 show exemplary upper and lower limits for ground conductor 80 sizes when used with a particular grounding member 90. For example, in FIGS. 3 and 4, a ⅝″ grounding member 90 is shown with a #1/0 AWG ground conductor 80, representing the upper limit ground conductor 80, and with a #1/0 AWG ground conductor 80, representing the lower limit ground conductor 80. FIGS. 5-6, 7-8, and 9-10 show the upper and lower limits for ground conductor 80 sizes with a grounding member 90 of ⅜″, ½″, and ¾″, respectively. Of course working combinations include all the ground conductor 80 sizes between the exemplary limits shown.

FIGS. 3-10 illustrate the flexibility of the ground clamp in accepting a variety ground conductor 80 and grounding member 90 sizes. In addition, Table 2 illustrates exemplary ranges of grounding member 90 and ground conductor 80 size combinations that may be secured within the inner region 60. In contrast, conventional ground clamps may be limited in that such conventional ground clamps are often particularly designed and configured accommodate only one size of grounding member with a limited range of ground conductor sizes. Aspects of a ground clamp as described herein essentially provide a universal apparatus which may replace such ground clamps configured for many different sizes and duties, thereby saving warehousing, inventory, and processing and manufacturing costs. In addition, field users need only maintain a single stock of universal ground clamps instead of many different sizes and duties of conventional ground clamps. Time savings may also be realized by minimizing or eliminating investigations to ascertain which size and duty of ground clamp is needed at a particular installation site, since a universal ground clamp according to the present invention can be used in most, if not all, field installation cases.

TABLE 2

| AWG | ⅜″ | ½″ | ⅝″ | ¾″ |
|---|---|---|---|---|
| #10 | X | X | X | |
| #8 | X | X | X | X |
| #6 | X | X | X | X |
| #4 | X | X | X | X |
| #2 | X | X | X | X |
| #1 | X | X | X | X |
| #1/0 | X | X | X | X |

Accordingly, the main body 5 is dimensioned to accept the variety of combinations. For example, as shown in FIG. 8, the main body is sufficiently sized to accommodate a grounding member/ground clamp combination with an overall dimension D′ calculated as 19.05 mm (¾″ grounding member)+9.47 mm (#1/0 AWG diameter ground conductor)=28.52 mm. Accordingly, referring to FIG. 1, dimension D′ is at least about 28.5 mm (i.e., such as about 30 mm) to accommodate the ¾″ grounding member and #1/0 AWG ground conductor combination. In FIG. 3, the main body 5 is sufficiently sized to accommodate a grounding member/ground clamp combination with a dimension D′ calculated as 15.88 mm (⅝″ grounding member)+9.47 mm (#1/0 AWG diameter ground conductor)=25.35 mm. Accordingly, in this instance, dimension D′ is at least about 25.35 mm to accommodate the ⅝″ grounding member and #1/0 AWG ground conductor combination. An acceptable range of values for D′ can therefore be, for example, between about 25 mm and about 35 mm.

Moreover, referring again to FIG. 1, an inner dimension F taken at a distance E from the inward facing surface 12 defining the “bottom” of the trough portion 20 is at least about 19 mm. At this point, as illustrated in FIG. 7, a ¾″ grounding member 90 can be received along a middle axis F′ within the inner region 60 when combined with an 8 AWG ground conductor. The dimension F′, shown in the example, is at least about 19 mm (¾″) to accommodate the full diameter of the ¾″ grounding member 90. An acceptable range for the inner dimension F′ is, for example, between about 19 mm and about 23 mm. The distance E from the inward facing surface 12 comprising the “bottom” of the trough portion 20 is calculated as 19.05 mm/2 (radius of ¾″ grounding member)+3.71 mm (#8 AWG diameter ground conductor)=13.2 mm from the inward facing surface 12 comprising the “bottom” of the trough portion 20.

In one instance, the main body 5 may be configured such that, upon the trough portion 20 receiving the smallest size ground conductor 80, the leg ends of the first and second leg portions 16, 17 are configured to be spaced apart so as to be capable of receiving the largest width grounding member 90 therebetween such that the largest width grounding member 90 contacts the smallest size ground conductor 80 and cooperates with the lateral support members 70 to retain the smallest size ground conductor 80 with respect to the trough portion 20.

The main body 5 can be comprised of metal alloy that comprises at least 80% copper. In one instance, the main body 5 is cast as a monolithic structure of a metallic material. It will be understood, however, that other materials, including non-metallic materials, can be used to for the main body 10 in addition to or instead of a metal alloy. In a preferred embodiment, the composition of the main body 5 includes approximately 85% copper. The remaining 15% preferably includes a combination of aluminum and lead. The thickness C of the wall 10 is preferably approximately 2.7 mm, but may be more or less. Tests have shown that this composition allows the main body 5 of the ground clamp to maintain structural integrity when a torquing force of up to 300 inch-pounds is applied to the threaded rod 40, which is considered a heavy duty ground clamp in the art. It should be appreciated that other compositions are possible and that the ground clamp may be made for lighter duty to save on material costs, or can be made for heavier duty such as up to 700 inch-pounds. For example, the thickness C may be less than 2.7 mm. The copper content may be 80% or more and/or other metals or non-metals may be used in the main body 5 in combination with the copper.

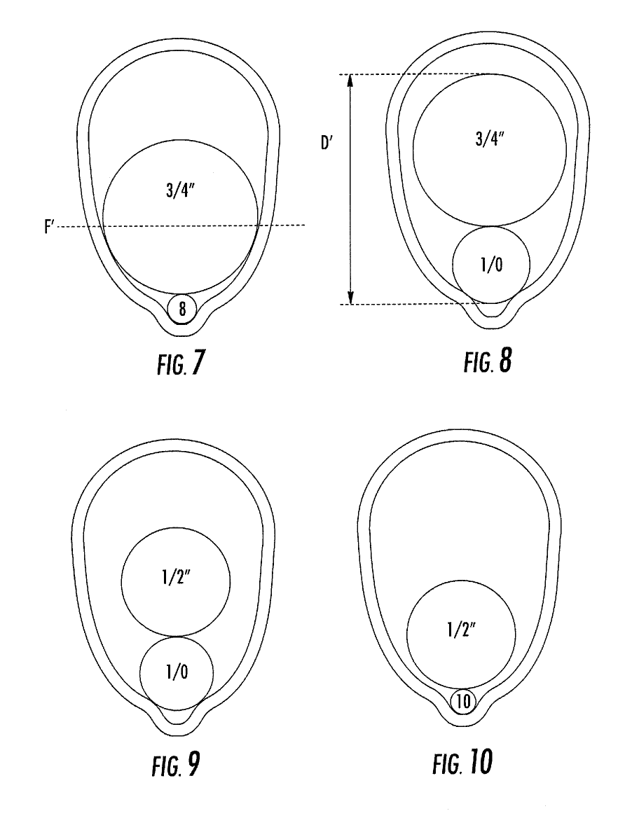

In an alternative embodiment, as shown in FIG. 11, a clamp body 100 may be formed from a single continuous strip of a metallic material having opposed longitudinal end portions 110, 120 configured to overlap such that the single strip defines an inner region 130 adapted to have therein a connection area for the ground conductor 80 to contact the grounding member 90. The clamp body 100 further includes spaced-apart first and second legs 140, 150 extending substantially perpendicularly to the overlapped opposed end portions 110, 120 and away therefrom to respective spaced-apart leg ends. First and second trough legs 160, 170 extend from the respective spaced-apart leg ends of the first and second legs 140, 150 and are directed away from the overlapped opposed end portions 110, 120. The first and second trough legs 160, 170 further converge to form a trough portion 180 of the clamp body 100. An aperture is defined by each of the overlapped opposed ends 110, 120 (indicated as elements 190 and 200) of the clamp body 100, wherein the apertures 190, 200 are aligned along an axis 210 extending substantially transversely to the inner region 130.

According to aspects of the present invention, each of the first and second trough legs 160, 170 defines an angle of between about 30 degrees and about 70 degrees with the axis 210. That is, the angle between each of the first and second trough legs 160, 170 and the axis 210 is between about 30 degrees and about 70 degrees. In one embodiment, the angle between each of the first and second trough legs 160, 170 and the axis 210 is about 50 degrees.

Since the opposed end portions 110, 120 overlap, one of the end portions comprises an inwardly disposed end portion 110 and the other end portion comprises an outwardly disposed end portion 120 with respect to the connection area within the inner region 130. In such instances, the aperture 200 defined by the outwardly disposed end portion 120 is no smaller than (i.e., is equal to or greater than) the aperture 190 defined by the inwardly disposed end portion 110. When the end portions 110, 120 are overlapped, the apertures 190, 200 may be aligned along the axis 210 as the clamp body 100 is formed in the folding or stamping process. In some instances, the folding or stamping process, in conjunction with the properties of the material comprising the clamp body 100 may be sufficient to retain the end portions 110, 120 in the overlapped position, with the apertures 190, 200 remaining aligned along the axis 210. In other instances, however, the overlapped inwardly disposed and outwardly disposed end portions 110, 120 may be secured together such as, for example, by welding (i.e., by spot welding) or in other manners (i.e., by an adhesive), so as to retain the apertures 190, 200 aligned along the axis 210, to form the clamp body 100, and to define the inner region 130.

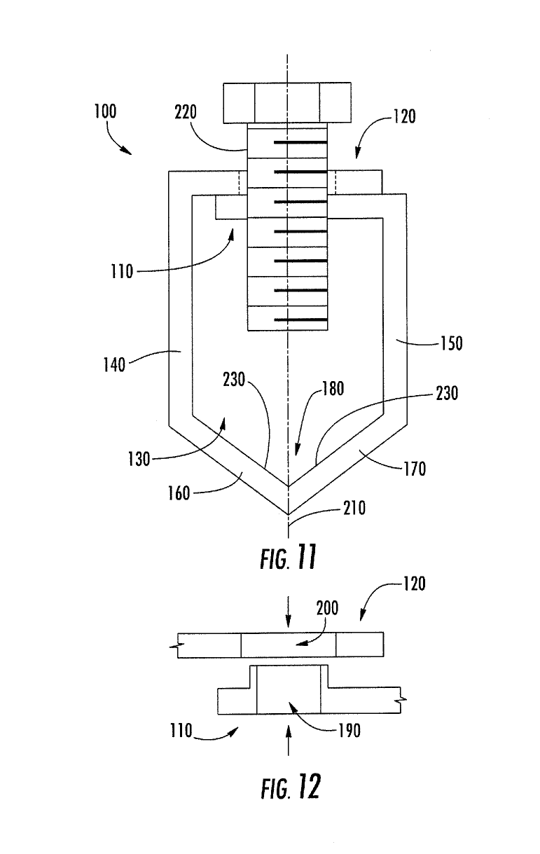

In one embodiment, the inwardly disposed end portion 110 defining the corresponding aperture 190 may be drawn away from the connection area (i.e., outwardly of the inner region 130) while the aperture 190 is formed, for example, as the aperture 190 is punched. In such instances, the drawn feature of the inwardly disposed end portion 110 may be configured to extend through the aperture 200 defined by the outwardly disposed end portion 120, which serves to align the aperture 200 defined by the outwardly disposed end portion 120 with the aperture 190 defined by the inwardly disposed end portion 110, as shown in FIG. 12. At least the aperture 190, in any instance, is configured to threadedly receive the threaded rod 220 such that the threaded rod 220 extends along the axis 210 (as do the aligned apertures 190, 200). In some instances, the aperture 200 may also be threaded for receiving the threaded rod 220. In one particular instance, both apertures 190, 200 are threaded.

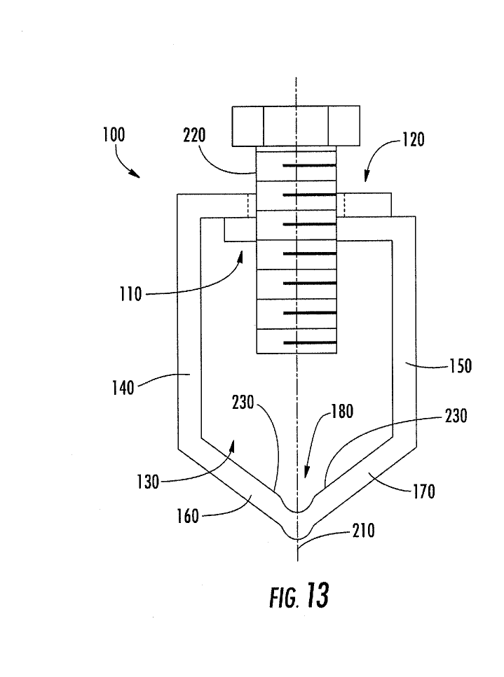

According to another aspect, the clamp body 100 may be formed such that the trough portion 180 is defined by a radius of curvature, similar to that disclosed in conjunction with the embodiment shown in FIG. 1 (see, e.g., FIG. 13). In such instances, the first and second trough legs 160, 170 converge and transition to the curved trough portion 180 via lateral support members 230 disposed therebetween, the lateral support members 230 being configured similarly to the lateral support members 70 disclosed in conjunction with the embodiment shown in FIG. 1. As such, the configuration and function of the curved trough portion 180 and associated lateral support members 230 will be understood and appreciated by one skilled in the art from the disclosure otherwise provided herein.

In any instance, the metallic material of the clamp body 100 may comprise, for example, stainless steel. However, one skilled in the art will appreciate that the clamp body 100 may be formed of any suitable material, whether metallic or nonmetallic, capable of being folded or stamped into a configuration as disclosed.

Installation of a ground clamp according to various aspects and embodiments of the present invention defines a method for connecting a ground conductor to a grounding member. Such a method includes inserting a grounding member through an inner region of a grounding apparatus, such as disclosed above in the several aspects of the present invention, inserting a ground conductor through the inner region and into a trough portion of the grounding apparatus, and threadedly advancing a threaded rod through a threaded hole of the grounding apparatus to force the grounding member against the ground conductor disposed within the trough portion. In this manner, the ground conductor is securedly maintained and retained within the trough portion with the lateral support members providing lateral support for the ground conductor.

Many modifications and other embodiments of the invention set forth herein will come to mind to one skilled in the art to which the invention pertains having the benefit of the teachings presented in the foregoing descriptions and the associated drawings. For example, each of the embodiments shown in FIGS. 11 and 13 may be formed from a tubular member (i.e., extruded tubing). That is, in some instances, a continuous tube may be rolled and formed to attain the particular cross-sectional shapes shown in FIGS. 11 and 13. In such instances, the clamp body 100 is formed as a single-piece monolithic member, which does not include overlapping ends 110, 120. Thus, only a single aperture is defined by the clamp body 100 for receiving the threaded rod 220. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus for connecting a ground conductor to a grounding member, the apparatus comprising:
a continuous annular wall encompassing and defining an inner region adapted to have therein a connection area for the ground conductor to contact the grounding member, the continuous annular wall having an inward facing surface and an outward facing surface with respect to the inner region, the inward facing surface including:
an arcuate portion having a first average radius of curvature and opposing ends, the arcuate portion further being configured so as to be concave with respect to the connection area and defining a medially-disposed aperture extending through the annular wall substantially transversely to the inner region;
first and second leg portions continuously, smoothly, and uninterruptedly extending from the respective opposing ends of the arcuate portion, and cooperating with the opposing ends to define a single continuous and uninterrupted taper having a continuously increasing taper rate, without any projection inward toward the connection area, away from the arcuate portion and to respective spaced-apart leg ends;
an arcuate trough portion disposed substantially opposite to the arcuate portion and having opposing ends and a second average radius of curvature less than the first average radius of curvature, the second average radius of curvature being less than half of a distance between the spaced-apart leg ends, the trough portion further being configured so as to be concave with respect to the connection area and having a depth greater than one-third of a width thereof; and
an arcuate interface extending between each of the first and second leg ends and the respective opposing ends of the trough portion, the arcuate interfaces being configured so as to be convex with respect to the connection area, each arcuate interface thereby having an increased taper rate with respect to the single continuous taper of, and as the arcuate interface extends from, the respective first and second leg ends, each arcuate interface further continuously, smoothly and uninterruptedly transitioning to a decreased taper rate upon extending to the respective opposing ends of the trough portion, the arcuate interfaces thereby forming opposing lateral support members adapted to maintain the ground conductor laterally within the trough portion when the ground conductor is received thereby.

2. An apparatus according to claim 1, further comprising a threaded rod configured to threadedly engage the annular wall defining the aperture, the threaded rod having a securement end extending toward the trough portion.

3. An apparatus according to claim 2, wherein the threaded rod is disposed along an axis substantially bisecting the trough portion.

4. An apparatus according to claim 1, wherein the annular wall is cast as a monolithic structure of a metallic material.

5. An apparatus according to claim 1, wherein the metallic material comprises a metal alloy including copper, aluminum, and lead.

6. An apparatus according to claim 2, wherein the annular wall is further configured such that the grounding member, when received in the inner region, is disposed between the securement end of the threaded rod and the ground conductor, the ground conductor being supported with respect to the trough portion between the lateral support members, such that contact between the grounding member and the ground conductor defines the connection area of the inner region.

7. An apparatus according to claim 1, wherein the inner region is configured to receive at least one grounding member having a width of between about ⅜ inches and about ¾ inches.

8. An apparatus according to claim 1, wherein the inner region is configured to receive at least one ground conductor having a size of between about #10 American wire gauge (AWG) and about #1/0 American wire gauge (AWG).

9. An apparatus according to claim 1, wherein, upon the trough portion receiving a smallest size ground conductor, the leg ends of the first and second leg portions are configured to be spaced apart so as to receive a largest width grounding member therebetween such that the largest width grounding member is capable of contacting the smallest size ground conductor and cooperating with the lateral support members to retain the smallest size ground conductor with respect to the trough portion.

10. A method for connecting a ground conductor to a grounding member, comprising:
inserting the ground conductor through an inner region defined and encompassed by a continuous annular wall, the inner region adapted to have therein a connection area for the ground conductor to contact the grounding member, the continuous annular wall having an inward facing surface and an outward facing surface with respect to the inner region, the inward facing surface including:
an arcuate portion having a first average radius of curvature and opposing ends, the arcuate portion further being configured so as to be concave with respect to the connection area and defining a medially-disposed aperture extending through the annular wall substantially transversely to the inner region;
first and second leg portions continuously, smoothly, and uninterruptedly extending from the respective opposing ends of the arcuate portion, and cooperating with the opposing ends to define a single continuous and uninterrupted taper having a continuously increasing taper rate, without any projection inward toward the connection area, away from the arcuate portion and to respective spaced-apart leg ends;
an arcuate trough portion disposed substantially opposite to the arcuate portion and having opposing ends and a second average radius of curvature less than the first average radius of curvature, the second average radius of curvature being less than half of a distance between the spaced-apart leg ends, the trough portion further being configured so as to be concave with respect to the connection area and having a depth greater than one-third of a width thereof; and
an arcuate interface extending between each of the first and second leg ends and the respective opposing ends of the trough portion, the arcuate interfaces being configured so as to be convex with respect to the connection area, each arcuate interface thereby having an increased taper rate with respect to the single continuous taper of, and as the arcuate interface extends from, the respective first and second leg ends, each arcuate interface further continuously, smoothly and uninterruptedly transitioning to a decreased taper rate upon extending to the respective opposing ends of the trough portion, the arcuate interfaces thereby forming opposing lateral support members adapted to maintain the ground conductor laterally within the trough portion when the ground conductor is received thereby;
inserting the grounding member through the inner region and moving the grounding member along the inner region toward the trough portion so as to contact the ground conductor received by the trough portion; and
threading a threaded rod, threadedly engaged with the annular wall defining the aperture, toward the trough portion such that a securement end thereof provides a clamping force for clamping the grounding member against the ground conductor, the ground conductor thereby being retained with respect to the trough portion by the grounding member in cooperation with the lateral support members.

11. A method according to claim 10, wherein threading a threaded rod further comprises threading a threaded rod along an axis substantially bisecting the trough portion.

12. An apparatus for connecting a ground conductor to a grounding member, the apparatus comprising:
a clamp body formed from a single continuous strip of a metallic material having opposed longitudinal end portions configured to overlap such that the single strip defines an interior region adapted to have therein a connection area for the ground conductor to contact the grounding member, the clamp body further including:
spaced-apart first and second legs extending substantially perpendicularly to the overlapped opposed end portions and away therefrom to respective spaced-apart leg ends; and
first and second trough legs extending from the respective spaced-apart leg ends and directed away from the overlapped opposed end portions, the first and second trough legs converging to form a trough portion of the clamp body; and
an aperture defined by each of the overlapped opposed ends of the clamp body, the apertures being aligned along an axis extending substantially transversely to the inner region.

13. An apparatus according to claim 12, wherein the metallic material comprises stainless steel.

14. An apparatus according to claim 12, wherein the opposed end portions include an inwardly disposed end portion and an outwardly disposed end portion with respect to the connection area.

15. An apparatus according to claim 14, wherein the aperture defined by the outwardly disposed end portion is no smaller than the aperture defined by the inwardly disposed end portion.

16. An apparatus according to claim 14, further comprising a threaded rod configured to threadedly engage at least the aperture defined by the inwardly disposed end portion, and to extend along the axis toward the trough portion.

17. An apparatus according to claim 18, wherein the axis substantially bisects the trough portion.

18. An apparatus according to claim 14, wherein the overlapped inwardly disposed and outwardly disposed end portions are welded together to form the clamp body.

19. An apparatus according to claim 14, wherein the inwardly disposed end portion defining the corresponding aperture is drawn away from the connection area, so as to extend through the aperture defined by the outwardly disposed end portion, so as to align the aperture defined by the outwardly disposed end portion with the aperture defined by the inwardly disposed end portion.

20. An apparatus according to claim 12, wherein clamp body is formed using at least one of a folding process and a stamping process.

21. An apparatus according to claim 12, wherein each of the first and second trough legs defines an angle of between about 30 degrees and about 70 degrees with the axis.

22. An apparatus according to claim 12, wherein each of the first and second trough legs defines an angle of about 50 degrees with the axis.

23. An apparatus according to claim 12, wherein the trough is configured to be arcuate, and the first and second trough legs transition to the arcuate trough via lateral support members disposed therebetween.
